(19) United States
(12) Patent Application Publication
(10) Pub. No.: US 2006/0075149 A1
(43) Pub. Date: Apr. 6, 2006

(54) Communications command control system with a software based at command receiver/transmitter

(75) Inventor: Anand C. Monteiro, San Diego, CA (US)

Correspondence Address: Howard Chen;Duane Morris, LLP, Spear Tower, Suite 2000, 1 Market, San Francisco, CA, 94105-1104, US

(73) Assignee: VIA Telecom Co., Ltd.

(21) Appl. No.: 10/956,820

(22) Filed: Oct. 1, 2004

(51) Int. Cl. G06F 3/00

(52) U.S. Cl. 710/5

(57) ABSTRACT

A communications command control system with a software-based AT command receiver/transmitter is disclosed. A data communications equipment (DCE) microprocessor is used for data computation. A communications application software is used for generating a communications command signal based on a set of communications commands. A software-based AT command receiver/transmitter is implemented for interfacing the communications application software with the DCE microprocessor.

### BACKGROUND

The present disclosure relates generally to AT (attention code) task-based command control systems, and more particularly to the elimination of the data terminal equipment (DTE) module by transferring its hardware and software functionality to the data communications equipment (DCE) modem module to reduce the AT task-based command control system equipment hardware cost while maintaining the same level of data communications performance.

A conventional AT task-based command control system utilizes a user interface DTE module and a wired or wireless DCE module to create a data communications link. A DTE device can be a PC or any control processor that provides a user interface that communicates with the DCE. A conventional DTE module consists of a DTE processor, its associated memory that contains an AT-command-based application software on the DTE device, and a hardware AT command receiver/transmitter (ATCRT) that provides data communication between the DTE and the DCE modules. Such data transmission is commonly used with modems and for non-networked communications between computers, terminals, and other devices.

The DTE microprocessor generates AT commands associated with the DTE application software and sends/receives these AT commands over a data interface provided by a hardware DTE ATCRT to the DCE ATCRT. ATCRT devices convert parallel digital bytes of data, input from a microprocessor, to a serial or parallel digital data stream for input to a second ATCRT that re-assembles the digital data stream into complete bytes of data for input to a microprocessor. ATCRT's may have FIFO buffers (first-in, first-out), which mean that the first data input to the ATCRT are the first data output from the ATCRT. The output of the DTE ATCRT can communicate in one direction to the input of the DCE ATCRT via an interface. To communicate in the opposite direction, the DCE ATCRT output is tied to the DTE ATCRT input.

For example one type of ATCRT is a Universal Asynchronous Receiver/Transmitter (UART). A UART uses asynchronous transmission to send data from the sending UART device to the receiving UART device without sending a clock signal to the receiving device. Instead, the sending and receiving devices must agree on timing parameters in advance, and special bits are added to each word, which are used to synchronize the sending and receiving devices. When a word is given to the sending UART for asynchronous transmission, a “start bit” is added to the beginning of each word to be transmitted. The “start bit” is used to alert the receiving UART that a word of data is about to be sent, and to force the clock in the receiving UART into synchronization with the clock in the sending UART. After the “start bit”, the individual bits of the word of data are sent, with the least significant (LSB) being sent first. Each bit in the transmission is transmitted for exactly the same amount of time. When the entire data word has been sent, the sending UART adds a “parity bit” so that the receiving UART can check this bit and verifies that the word has been received correctly. Then the sending UART transmits a “stop bit” indicating the end of the word. If the “parity bit” check is not correct, it is deemed by the system that data bits are not received correctly. If the “parity bit” check is valid and the receiving UART finds the “stop bit”, the receiving UART is ready for the next word transmission. RS232 is one example of a serial interface used in this type of data communications.

Some DTE applications are uncomplicated data monitoring applications that use simple microprocessors, flash memory, and SRAM while other applications are more complex. If the data monitoring application software is written using the defined AT command set, it can communicate with any wired or wireless DCE module that supports the AT command set.

A conventional DCE module consists of an embedded microprocessor, flash memory, SRAM, hardware ATCRT device, and a multi-tasking operating system. The DCE module communicates bi-directionally with the DTE module via the hardware ATCRT's. The DCE module can be either a wired or wireless modem to communicate with the external information source to provide a number of functions. For example, a wireless DCE module utilizing the AT command set may be connected to an external cellular phone system for short message service (SMS), originate voice calls, data browser, or other cell phone functions. The wireless modem could be a GSM (global system for mobile communication), CDMA (code division multiple access), PHS (payload header suppression), or other type of modem.

The AT task-based command control system utilizes the AT command set, which is an industry standard, to initialize and communicate with a modem, which is a device that converts data from digital computer signals to analog signals that can be sent over a phone line (such as an Internet modem) or through the air (such as a wireless modem). This process of converting digital signals to analog signals is called modulation. The analog signals are converted back to the digital signals after transmission to its destination modem by the process of demodulation. A modem supports the standard and extended Hayes AT (attention code) command set. A modem is in either the command mode or the on-line mode. The modem powers up in the command mode in which the AT commands set such parameters as the Baud rate and the number of start/stop bits for the modem. Commands are only accepted by the modem when it is in command mode. In the on-line mode, any information inputted to the modem is treated as data. Settings made via AT commands are automatically reused by the modem until another command is received to change them, or the modem is turned off.

Desirable in the art of AT task-based command control systems are new designs that eliminate redundant hardware thereby reducing equipment costs while maintaining data communications performance.

### SUMMARY

The present invention discloses a method and communications command control system. In one embodiment, the system includes a data communications equipment (DCE) microprocessor for data computation. A communications application software is implemented for generating a communications command signal based on a set of communications commands. A software-based AT command receiver/transmitter is used for interfacing the communications application software with the DCE microprocessor.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 presents a conventional task-based AT command control system.

FIG. 2 presents a modified task-based AT command control system in accordance with one example of the present disclosure.

### DESCRIPTION

In the present disclosure, an example of the modified task-based AT command control system provides a system and method to eliminate the data terminal equipment (DTE) module of the AT task-based command control system by transferring the DTE software and hardware functionality to the data communications equipment (DCE) modem module and to use a software-based ATCRT in place of the hardware ATCRT.

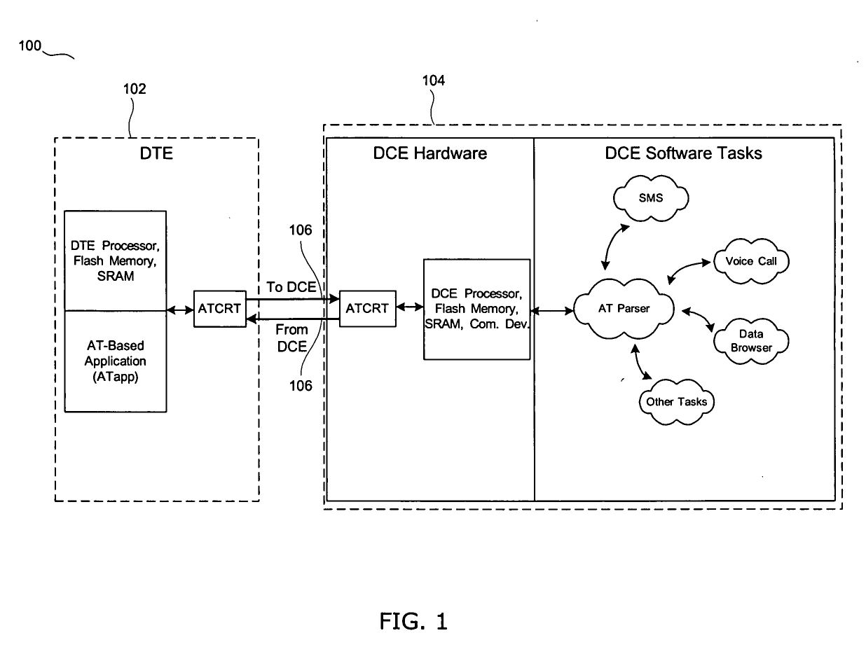

FIG. 1 presents a conventional task-based AT command control system 100 comprised of a DTE (data terminal equipment) module 102 and a DCE (data communications equipment) module 104. The DTE module 102 may be a predetermined module of a PC (personal computer) or any control processor that communicates with the DCE module 104. For example, the DTE module 102 may include a DTE processor (such as an Intel 8051 processor), its associated flash memory that contains a communications application software such as an AT command-based application software (ATapp), SRAM, and a hardware ATCRT that provides data conversion, and data communication between the DTE module 102 and the DCE module 104. The data links 106, such as serial links or parallel links, transmit signals (AT commands and data) bi-directionally between the DTE and the DCE modules via the ATCRT's. Such ATCRT includes, but not limited to, UART, and other devices that are able to transmit AT commands using technical standards, such as USB, RS-232, IrDA, WiFi and Bluetooth. If the data monitoring application software on the DTE is written using the defined AT command set, it may communicate with any DCE module that supports the AT command set.

Table 1 is a partial list of AT commands. The modem initialization string consists of a series of commands. It prepares the modem for communications, setting such features as dialing mode, waits, detection of the busy signal and many other settings. Newer modem communications programs reset the initializations string automatically according to which menu options are selected, and which features are enabled. For many years Hayes modems have been the standard in modems. As the field of modem manufactures has grown, most have adhered at least loosely to the Hayes standard. By providing a new AT command control system design that provides at least some backward compatibility to the above mentioned standards, redundant hardware may be eliminated, while data communications performance and integrity can still be maintained.

TABLE 1

| | |
|---|---|
| % Cn | Enable/Disable Data Compression |
| % En | Auto-Retrain Control |
| &Cn | DCD Control |
| &Dn | DTR Option |
| &Fn | Recall Factory Profile |
| &Gn | Select Guard Tone |
| &Jn | Telephone Jack Control |
| &Kn | Data Flow Control |
| &Qn | Communication (Sync/Async Mode) |
| &Rn | RTS/CTS (Hardware) Flow Control |
| &Tn | Test Mode |
| &V | View Configuration |
| &Wn | Store User Profile |
| &Yn | Default User Profile |
| &Zn*x | Store Phone Number |
| )Mn | Cellular Power Level Adjustment |
| Hn | Link Negotiation Speed |
| +++ | Escape Sequence |
| +MS | Select Modulation |
| :En | Compromise Equalizer Setting |
| ? | Read Currently Selected S Register |
| @Mn | Initial Cellular Power Level Setting |
| \An | Select Maximum MNP Block Size |
| \Bn | Transmit Break |
| \Gn | Modem to Modem (Software) Flow Control |
| \Ln | Select MNP Block/Stream Mode |
| \Nn | Protocol Negotiation Selection |
| A | Answer |
| A/ | Re-execute Command |
| Bn | CCITT or Bell Selection |
| Cn | Carrier Control |
| Dn | Dial |
| En | Command Echo |
| Fn | Select Modulation |
| Hn | Disconnect (Hang-up) |
| In | Identification |
| Ln | Speaker Volume |
| Mn | Speaker Control |
| Nn | Automode Enable (Automatic Line Speed Detection) |
| On | Return to On-Line Data Mode |
| P | Set Pulse Dial Default |
| Qn | Result Code On/Off |
| Sn | Select a Specific S Register |
| Sn*x | Write an S register Value |
| Sn? | Read an S register |
| T | Set Tone Dial Default |
| Vn | Result Code Format |
| Wn | Negotiation Progress (Connect Message) Control |
| Xn | Extended Result Code |
| Yn | Long Space Disconnect |
| Zn | Modem Reset |

The DCE module 104 may include the DCE hardware components and the DCE software tasks applications. The DCE hardware may further include the ATCRT, DCE processor (such as ARM7S), flash memory, SRAM, and communications device (wired or wireless). The data links 106 transmit signals (AT commands and data) bi-directionally between the DTE and the DCE modules via the ATCRT's. The AT commands and data from the DTE are routed by the DCE ATCRT to the DCE processor for execution of the desired task as requested by the DTE user. The DCE also sends AT commands and data back to the DTE via the DCE processor, ATCRT's, and the data links 106. The DCE processor executes a multi-tasking operating system to complete the necessary software tasks required by an AT parser. In this example, the AT parser communicates with a wireless communication device (using GSM, CDMA, PHS, or other protocol) via the DCE processor to execute the SMS, voice call, data browser, and other required tasks on the multi-tasking operating systems. All of these tasks are initiated, controlled, and monitored by the AT parser. The AT parser also executes as a software task in the DCE multi-tasking operating system. The AT parser receives AT commands from the DTE via the ATCRT's, interprets the AT commands, and then communicates with the other DCE tasks. Conversely, the. DCE tasks will send status information to the AT parser task, and the AT parser will use AT commands to return status information through the ATCRT's to the DTE module.

One main disadvantage of the conventional task-based AT command control system 100 is that the application executing on the DTE module may be a very simple application. Even such a simple application requires the system overhead of a DTE microprocessor, DTE flash memory, DTE SRAM, and two hardware ATCRT's (DTE and DCE). This adds significant cost to the overall data communications system.

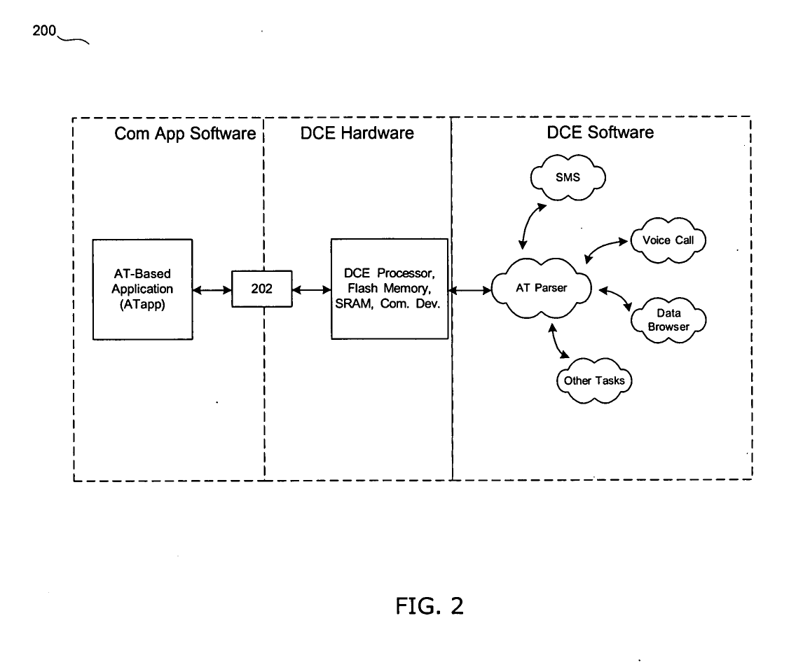

FIG. 2 presents a modified communications command control system such as a task-based AT command control system 200 in accordance with one example of the present disclosure. The modified task-based AT command control system 200 completely eliminates the need for the DTE module by transferring the DTE hardware and software functional requirements to the DCE module. A typical DCE module has sufficient additional computing power, additional flash memory, and SRAM storage capability to incorporate the additional AT-Based Application (ATapp) software as well as the implementation of a new software-based ATCRT 202 to replace the two hardware ATCRTs (DTE & DCE) in the conventional AT command control system 100. The DCE multitasking operating system will easily allow incorporation of the ATapp software and the software-based ATCRT implementation with the existing DCE tasks, thereby allowing a seamless portability of software from the ATapp software user interface to the DCE processor. The software-simulated ATCRT preserves the same interfaces for the ATapp tasks that were originally used on the DTE. No change to the DCE software is required; rather, the new software-based ATCRT implementation will allow for communication between the ATapp application and the DCE processor through the software-based or simulated ATCRT 202.

The software-based ATCRT transmits AT commands, using technical standards, such as RS 233, USB, IrDA, WiFi and Bluetooth. For example, the software-based ATRCT may be a software-simulated UART, using RS232 standard for transmission of AT commands. In this example, a sending UART uses a “start bit” to alert a receiving UART that a word of data is about to be sent. When the entire data word has been sent, the sending UART adds a “parity bit” so that the receiving UART can verify that the word has been received correctly. If the “parity bit” check is valid and the receiving UART receives a “stop bit,” the receiving UART will be ready for the next word transmission.

As the example in FIG. 1, the AT parser communicates with a wireless communications device (using GSM, CDMA, PHS, or other protocol) for accessing an external information source such as a base station or server as assisted by the DCE processor to execute the SMS, voice call, data browser, and other required tasks on the multi-tasking operating system. All of these tasks are initiated, controlled, and monitored by the AT parser upon a request from the ATapp application. The AT parser in FIG. 2 controls, and receives AT commands from the DCE processor via the software-based ATCRT 202 from the ATapp application. It interprets the AT commands, and then initiates, executes, or communicates with one or more DCE tasks. Conversely, the DCE tasks will send status information to the AT parser, and the AT parser will use AT commands to return the status information through the software-based ATCRT 202 back to the ATapp application.

The modified task-based AT command control system 200 requires that the ATapp software be modified to enable a software-based ATCRT capability. For example, the elimination of the DTE processor, such as Intel 8051, DTE Flash memory, DTE SRAM, and both hardware ATCRT's (DTE and DCE) greatly reduces the recurring equipment cost while maintaining data communications integrity. The improved design uses the processing power of the microprocessor of the DCE, and eliminates the need of additional processing devices. The non-recurring software design cost is insignificant when compared to the recurring hardware equipment costs. The modified task-based AT command control system 200 also provides a method to implement data flow control on a DCE module that allows data to be re-transmitted if an error is detected.

The above disclosure provides many different embodiments or examples for implementing different features of the disclosure. Specific examples of components and processes are described to help clarify the disclosure. These are, of course, merely examples and are not intended to limit the disclosure from that described in the claims.

Although the invention is illustrated and described herein as embodied in a design and method to eliminate the data terminal equipment (DTE) module of an AT task-based command control system by transferring the DTE functionality/circuitry to the data communications equipment (DCE) modem module, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the disclosure, as set forth in the following claims.

What is claimed is:

1. A communications command control system comprising:
a data communications equipment (DCE) microprocessor for data computation;
a communications application software for generating at least one communications command signal based on a set of communications commands; and
a software-based attention code (AT) command receiver/transmitter (ATCRT) for interfacing the communications application software with the DCE microprocessor.

2. The communications command control system of claim 1 wherein the software-based ATCRT establishes a data link between the DCE microprocessor and the communications application software.

3. The communications command control system of claim 1 wherein the software-based ATCRT is a software simulated universal asynchronous receiver/transmitter (UART).

4. The communications command control system of claim 1 wherein the software-based ATCRT transmits communications commands using a technical standard of USB, RS-232, IrDA, WiFi, or Bluetooth.

5. The communications command control system of claim 1 further comprising an AT parser that interprets the communications command signal received via the software-based ATCRT.

6. The communications command control system of claim 5 further comprising at least one software task controlled by the AT parser.

7. The communications command control system of claim 6 wherein the AT parser returns a status information regarding the communications application software via the software-based ATRCT.

8. The communications command control system of claim 7 wherein the DCE mnicroprocessor has a capacity sufficient to accommodate processing needs of the communications application software, the software-based ATCRT, the AT parser, and the software task.

9. A method for controlling a data flow using a set of standardized communications commands between an attention code (AT) command-based application software (ATapp) and a data communications equipment (DCE), the method comprising:
generating at least one communications command signal by the ATapp for initiating a communication task;
receiving the signal through a software-based AT command receiver/transmitter (ATCRT) by a microprocessor of the DCE; and
processing the signal by an AT parser of the DCE for executing the communication task.

10. The method of claim 9 further comprising establishing a data link between the ATapp and the microprocessor.

11. The method of claim 9 wherein the DCE executes the communication task for further communicating with an external information source.

12. The method of claim 9 wherein the ATapp is stored in a storage device coupled to the microprocessor on the DCE.

13. A data communication equipment (DCE) system comprising:
a microprocessor for data computation;
an attention code (AT) command-based application software for generating at least one communications command signal; and
a software-based universal asynchronous receiver/transmitter (UART) for interfacing the AT command-based application software with the microprocessor.

14. The system of claim 13 wherein the software-based UART uses a parity signal to verify a correctness of data communication between the microprocessor and the AT command-based application software.

15. The system of claim 13 further comprising an AT parser for executing a DCE software task, according to the communications command signal, to interface with an external information source.

16. The system of claim 15 wherein the AT parser interprets the communications command signal received via the software-based UART.

17. The system of claim 16 wherein the AT parser uses the microprocessor for data processing.

18. The system of claim 17 wherein the AT parser returns a status information regarding the DCE software task to the AT command-based application software via the software-based UART.
